(19) United States
(12) Patent Application Publication
(10) Pub. No.: US 2020/0002796 A1
(43) Pub. Date: Jan. 2, 2020

(54) METHOD FOR PRODUCING A SUBASSEMBLY HAVING FORM-FITTING CONNECTION AND SUBASSEMBLY HAVING FORM-FITTING CONNECTION WITH PRECIPITATION-HARDENED FORM-FITTING REGION

(71) Applicant: MTU Aero Engines AG, Munchen (DE)

(72) Inventors: Julian VON LAUTZ, Muenchen (DE); Michael WEISS, Dachau (DE); Markus SCHLEMMER, Mainburg (DE); Kamil MATUSZEWSKI, Karlsfeld (DE); Anna KIRZINGER, Muenchen (DE)

(73) Assignee: MTU Aero Engines AG, Munchen (DE)

(21) Appl. No.: 16/456,229

(22) Filed: Jun. 28, 2019

(30) Foreign Application Priority Data
Jun. 29, 2018 (DE) 10 2018 210 743.2

(51) Int. Cl. C22F 1/10; F16B 19/04; F16B 5/04

(52) U.S. Cl. CPC C22F 1/10; F16B 5/04; F16B 19/04

(57) ABSTRACT

The present invention relates to a method for producing a subassembly having a form-fitting connection with a precipitation-hardened form-fitting region as well as a corresponding subassembly, wherein at least two components of a subassembly are provided that are connected together in form-fitting manner, wherein each of the components has a form-fitting region that can come in contact with at least one other form-fitting region of the other component to be connected, in order to produce a form-fitting connection by limiting at least one degree of freedom of movement of the connected components relative to one another, wherein at least one of the components has at least one deformation form-fitting region for providing the form-fitting connection that is reshaped for producing the form-fitting connection after arranging the components to be connected relative to one another, in order to produce the form-fitting connection.

### BACKGROUND OF THE INVENTION

### Field of the Invention

The present invention relates to a method for producing a subassembly having a form-fitting connection with a precipitation-hardened form-fitting region as well as a subassembly having at least one precipitation-hardened or precipitation-hardenable form-fitting region and corresponding components, such as rivets, crimping sleeves or locking plates, which can be precipitation-hardened.

### Prior Art

Form-fitting connections are utilized in many engineering fields for connecting components to subassemblies. An example therefor are rivets that are utilized for the connection of components, wherein, for example, a rivet is inserted as a pin into a passage opening of two components to be joined, and the ends of the pin in the form of rivet heads serve for the purpose of no longer allowing the rivet to be removed from the passage opening, whereby at least one rivet head is produced by deforming one end of the rivet after the rivet is inserted in the passage opening. In particular, rivets can also be employed in engine construction for aircraft engines, for example, in order to join together components of housing structures or flow channel boundary walls of aircraft engines.

Additional examples of form-fitting connections that are also used particularly in engine construction for aircraft engines are crimping connections, such as connections of profiled pins with crimping sleeves, or securing elements.

In applications in turbomachines, such as gas turbines or aircraft engines, form-fitting connections are subjected to high temperatures during operation, wherein the form-fitting connections must have a sufficient strength even at these high temperatures for secure connection of the components.

Correspondingly, it is advantageous if the connected components and, in particular, the form-fitting regions thereof have a high strength at high temperatures. This means, of course, that in the reshaping for producing the corresponding connection, components of this type such as rivets or crimping sleeves have a high resistance to deformation that may enable only a small degree of reshaping, so that a form-fitting connection can barely be produced or produced only with great difficulty when reshaping a high-strength material, and especially a material with high heat resistance.

### SUMMARY OF THE INVENTION

### Object of the Invention

Therefore, it is the object of the present invention to provide a method for producing a form-fitting connection from a material with high strength, in particular a material with high heat resistance, as well as corresponding components, such as rivets, crimping elements or securing elements; and subassemblies of form-fitting, connected components that can be employed, in particular, in aircraft engine construction. The form-fitting connections shall be easy to produce thereby, or the corresponding method shall be simple to carry out, but nonetheless shall make possible reliable connections even at high use temperatures.

### Technical Solution

This object is achieved by a method and components therefor of the present invention. Advantageous embodiments are discussed in detail below.

According to the invention, a form-fitting connection is provided for connecting at least two or three components into a subassembly, in which the components to be joined have form-fitting regions, by which the components to be joined together can come into contact, in order to limit at least one degree of freedom of movement of the connected components relative to one another, so that a form-fitting connection is produced.

For example, by its head regions that are enlarged in diameter and correspond to form-fitting regions, a rivet can no longer be removed from a passage opening of two components to be connected in the lengthwise direction of the rivet or in the axial direction of the passage opening, since the enlarged head regions of the rivet do not fit through the passage opening. In the case of crimping connections, for example a crimping sleeve, the crimping sleeve can no longer be removed from a pin on which the crimping sleeve is arranged, since the crimping sleeve projects into corresponding depressions or surrounds projections of the pin after it has been crimped. Moreover, a plurality of other, different form-fitting connections is conceivable, in which at least two components are fixed in place in at least one degree of freedom of movement based on reshaping.

The present invention now proposes to provide, in order to produce a subassembly with a form-fitting connection in which at least two components of the subassembly are connected together in form-fitting manner, at least one of the components with at least one deformation form-fitting region, which is reshaped for producing the form-fitting connection after a mutual arrangement of the components to be connected, in order to produce the form-fitting connection, wherein the deformation form-fitting region is formed from a material that can be hardened by formation of precipitations. By providing at least one component having at least one deformation form-fitting region that is produced from a hardenable material, it is possible to carry out the deformation of the deformation form-fitting region when the deformation form-fitting region is in a state in which it is not hardened, or is found in an unhardened state due to a solution annealing and subsequent quenching. In this way, a reshaping with less resistance and thus a simpler reshaping of the deformation form-fitting region is possible.

After the reshaping of the deformation form-fitting region in the unhardened state, the deformation form-fitting region is subjected to an aging or precipitation heat treatment, so that the material that can be hardened by precipitations forms precipitations, and in this way, the deformation form-fitting region is hardened. Correspondingly, after the precipitation heat treatment or aging heat treatment in the deformation form-fitting region, a hardened material is present that has a high strength and particularly also a high heat resistance. Correspondingly, a stable form-fitting connection and, in particular one that is also stable at high temperatures, can be produced. Due to the use of a deformation form-fitting region that is deformed after arranging the components to be connected in order to produce the form-fitting connection in the unhardened state, a simple production is possible, wherein, after the aging heat treatment, the form-fitting region formed by the deformation form-fitting region also has a high strength and, in particular, a high heat resistance.

The aging heat treatment can take place in a locally limited manner on the local area of the deformation form-fitting region. Alternatively, the entire component having the deformation form-fitting region or the entire subassembly with the connected components can also be subjected to the corresponding heat treatment for depositing the precipitations in the deformation form-fitting region.

The local aging heat treatment of the deformation form-fitting region may be carried out by inductive heating and/or an energy-rich radiation, such as, in particular, laser radiation, electron beam radiation and/or infrared radiation.

In the case of temperature-stressed subassemblies or components, such as in subassemblies of gas turbines or aircraft engines, in particular, the aging or precipitation heat treatment can take place first during operation or when using the subassembly or component with the as yet unhardened connection form-fitting region.

The invention can be utilized in many different form-fitting connections, in particular for rivets, crimping connections, and/or securing elements, in particular in high-temperature applications, such as in subassemblies of turbomachines, particularly aircraft engines or stationary gas turbines.

For example, a rivet can be formed from a precipitation-hardenable material, such as, e.g., a nickel-based superalloy, wherein the hardenable material provides the rivet connection with a high strength and, in particular, a high-temperature resistance. However, in order to be able to easily produce the rivet connection, having requires a reshaping of the rivet for producing a form-fitting connection with the riveted structure, the reshaping of the rivet is conducted in an unhardened state and, in particular, in a solution-annealed state, since the production of the rivet connection is simplified due to the lower strength in the solution-annealed state and the possible higher degree of reshaping associated therewith.

Correspondingly, according to the present invention, a rivet made of a precipitation-hardenable material will be provided, and, in particular, of a nickel-based superalloy or a cobalt-based alloy, in the unhardened state or in the solution-annealed state, and, after arranging the rivet in the structure in which the rivet connection shall be produced, the rivet in the unhardened state or in the solution-annealed state is reshaped for the formation of the form-fitting connection.

After the reshaping of the rivet with the formation of at least one rivet head, the structure with the reshaped rivet is subjected to an aging heat treatment, so that the strength-producing precipitations can be precipitated. After the precipitation heat treatment, a rivet connection with a very strong rivet and particularly one with high heat resistance is present, which is hardened by the precipitations formed during the precipitation heat treatment.

The rivet can preferably have a rod-shaped, in particular a cylindrical, basic body, and at the axial ends thereof, at least one or two deformation form-fitting region(s) is or are provided, which are reshaped with the production of the rivet connection, in order to produce a form-fitting connection of the components that are connected.

Other examples of form-fitting connections in which the present invention can be applied are crimping connections or securing elements, such as locking plates that prevent the axial displacement of a blade root in a blade root groove of a rotating disk of a turbomachine.

A crimping connection can be produced, for example, by a crimping sleeve in connection with a pin, wherein the pin can have a cylindrical basic body with depressions and/or projections, to which the crimping sleeve can be applied according to a crimping process. For example, annular circumferential grooves and/or projections can be provided on the cylindrical basic body of a pin, and the crimping sleeve can have a cylinder-shaped deformation form-fitting region that is shrunk onto the pin in the region of the grooves or projections.

In the case of locking plates for the axial securing of rotating blades in a rotating disk, a locking plate can have regions at its ends that are enlarged in width, these regions protruding from the groove after the locking plate has been inserted into the base of the groove, and, after they are bent toward the end faces of the disk, prevent an axial displacement inside the groove.

The reshaping of the deformation form-fitting region can be carried out as cold forming, so that after a solution-annealing treatment, the deformation form-fitting region is reshaped in the cooled or quenched state for producing the form-fitting connection.

All precipitation-hardenable materials come into consideration as materials for the deformation form-fitting region, wherein, in particular, nickel-based or cobalt-based alloys can be employed for application in the high-temperature region, such as, for example, in rotating blades of aircraft engines. As nickel-based superalloys, for example, alloys such as Inconel IN718, C263, Nimonic 80, MAR M247, SC 2000 or PWA 1480 are considered.

A solution-annealing treatment of the precipitation-hardenable material made of a nickel-based superalloy can be carried out in the temperature range from 900° C. to 1200° C., in particular 940° C. to 1065° C., for 0.5 to 5 h, in particular 1 to 2 h.

The aging heat treatment subsequent to the reshaping of the at least one deformation form-fitting region can be carried out at temperatures of 550° C. to 850° C., in particular 620° C. to 790° C., for 1 to 15 h, in particular 2 to 10 h.

### BRIEF DESCRIPTION OF THE DRAWING FIGURES

In a purely schematic manner, in the appended drawings,

FIG. 1 shows an illustration of a rivet connection of two components prior to reshaping the rivet;

FIG. 2 shows an illustration of a rivet connection of two components after reshaping the rivet;

FIG. 3 shows an illustration of a crimping connection;

FIG. 4 shows a perspective illustration of a rotating blade;

FIGS. 5 to 7 show illustrations of a blade root connection of a rotating blade, having a disk with a locking plate for the axial securing of the blade root, wherein, in the a) figure parts, in each case, a cross section is shown through the groove for the uptake of the blade root as well as through the blade root crosswise to the axis of rotation of the disk, and in the b) figure parts, an axial longitudinal section is shown through the groove for the uptake of the blade root and through the blade root; and

FIG. 8 shows a perspective illustration of the locking plate from FIGS. 4 to 6.

### DESCRIPTION OF THE INVENTION

Further advantages, characteristics and features of the present invention will be clarified in the following detailed description of the examples of embodiment. Of course, the invention is not limited to these embodiment examples.

In a purely schematic illustration, FIG. 1 shows a rivet connection before the rivet 3 has been reshaped for producing the rivet connection. The rivet connection of FIG. 1 connects the components 1 and 2, wherein the rivet is pushed through an opening in the components 1 and 2.

The rivet 3 in the embodiment example shown has the shape of a cylindrical rod and has two deformation form-fitting regions 4 and 5 at its axial ends, which are reshaped in the production of the rivet connection, so that a form-fitting connection is formed that holds together the components 1 and 2.

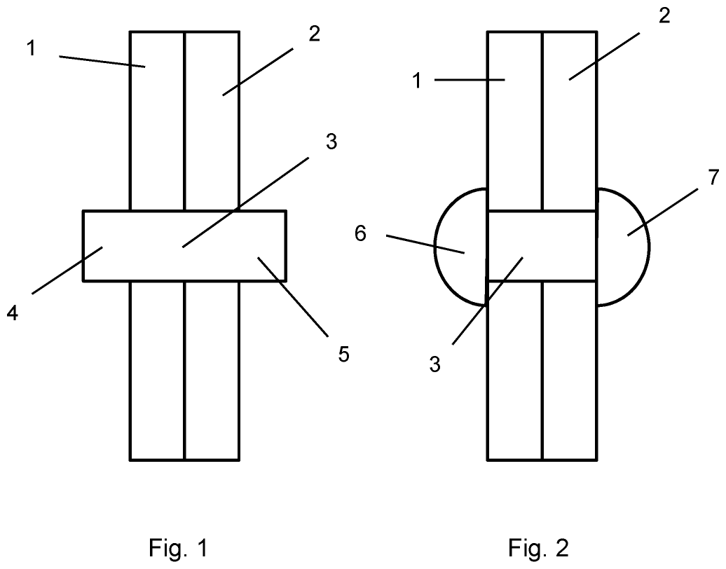

This situation after the reshaping is shown in FIG. 2. FIG. 2 shows the rivet 3, each time with a reshaped rivet head 6, 7 at the respective axial ends of the cylinder-shaped basic body of the rivet 3. The hemisphere-shaped rivet heads 6, 7 are created by appropriate cold forming of the deformation form-fitting regions 4 and 5 of the rivet 3.

Instead of the shape of the rivet 3 shown in the embodiment example of FIGS. 1 and 2 with a cylinder-shaped basic body and hemisphere-shaped rivet heads 6, 7 after the reshaping of the rivet for producing the rivet connection, other suitable shapes of the rivet and corresponding other shapes of the reshaped regions can also be used. In particular, rivets that possess only one deformation form-fitting region and already have one preformed rivet head can also be employed.

According to one embodiment example according to the invention, the rivet 3 is formed from a precipitation-hardenable material, wherein, for example, a nickel-based superalloy can be selected, which can be hardened by intermetallic precipitations in the form of Ni₃(Al, Ti, Nb) precipitations, the so-called γ′ phases, and/or by carbides. A typical nickel-based superalloy that can be employed for a rivet according to the invention is marketed under the trade name Inconel IN718, and has a chemical composition of 0.04 at. % carbon, 19 at. % chromium, 3 at. % molybdenum, 52.5 at. % nickel, 0.9 at. % aluminum, ≤0.1 at. % copper, 5.1 at. % niobium, 0.9% titanium, and the remainder of iron along with unavoidable contaminants.

The rivet 3 made of a corresponding precipitation-hardenable alloy such as Inconel 718 is inserted in the solution-annealed state into the opening passing through the components 1, 2, and reshaped in the solution-annealed state. The solution annealing can be conducted for Inconel 718 in the temperature range of 940° C. to 1065° C., for example at 980° C., for 1 hour. After the solution annealing, the rivet 3 is cooled in water or oil or in air, and then can be cold reshaped in the solution-annealed state for the formation of the rivet connection in the deformation form-fitting regions 4 and 5 at the axial ends of the rivet 3.

After the reshaping of the deformation form-fitting regions 4, 5 to the reshaped rivet heads 6, 7, the riveted structure composed of the components 1, 2 and the rivet 3 are subjected to an aging heat treatment, which can take place at a temperature of 700° C., for example, for 2 hours. During this time, there occurs aging of precipitations, for example, for the precipitation of γ′ phases in the case of the Inconel 718 alloy. The precipitations formed during the aging heat treatment endow the rivet 3 with a high strength, particularly also high strength at high temperatures. After the aging heat treatment, the production of the rivet connection is terminated.

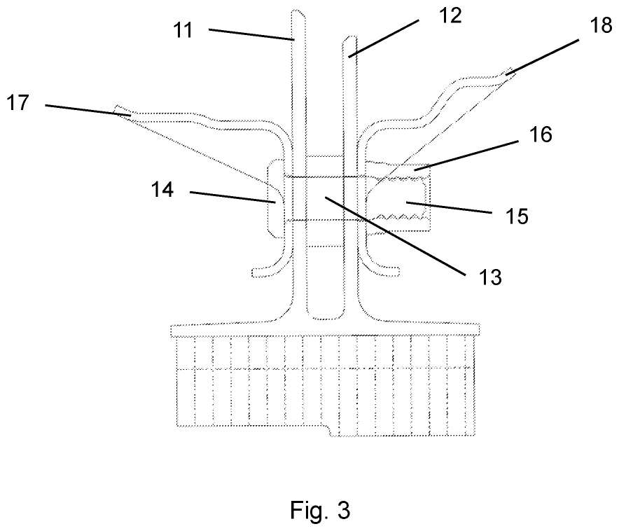

Another example of a subassembly according to the invention and the production thereof is shown in FIG. 3 for the arrangement of fairings 17, 18 at sealing fins 12, 13 in an aircraft engine. For the arrangement of fairings 17, 18, a connection pin 13 is used, which is arranged in the sealing fins 11, 12 and the fairings 17, 18 through corresponding passage openings. The connection pin 13 has a pin head 14, the diameter of which is larger than the diameter of the cylindrical pin body, so that the pin head 14 does not fit through the passage openings. A holding region 15 that has a plurality of annular circumferential depressions and elevations on its outer surface is formed at the opposite-lying end of the connection pin 13. In order to fasten the connection pin 13 in the passage opening, a crimping sleeve 16 is arranged over the holding region 15 and is pushed over the holding region 15 and then is pressed onto the connection pin 13, so that the crimping sleeve 16 engages in the annular circumferential depressions of the holding region 15 of the connection pin 13, and the annular elevations of the holding region 15 of the connection pin 13 engage in the inner surface of the crimping sleeve 16. In order to make possible an easy deformation of the crimping sleeve 16, the crimping sleeve 16, just like the first deformation form-fitting region 4 and the second deformation form-fitting region 5 of the rivet 3 of the previous embodiment example, is formed from a precipitation-hardenable material, which is crimped in the solution-annealed state onto the holding region 15 of the connection pin 13, in order to subsequently form precipitations by an aging heat treatment so as to increase the strength of the crimping sleeve 16 and thus the connection.

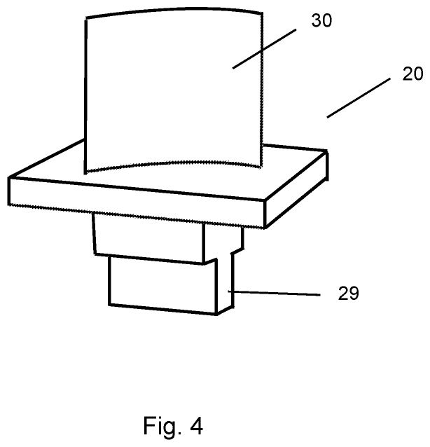

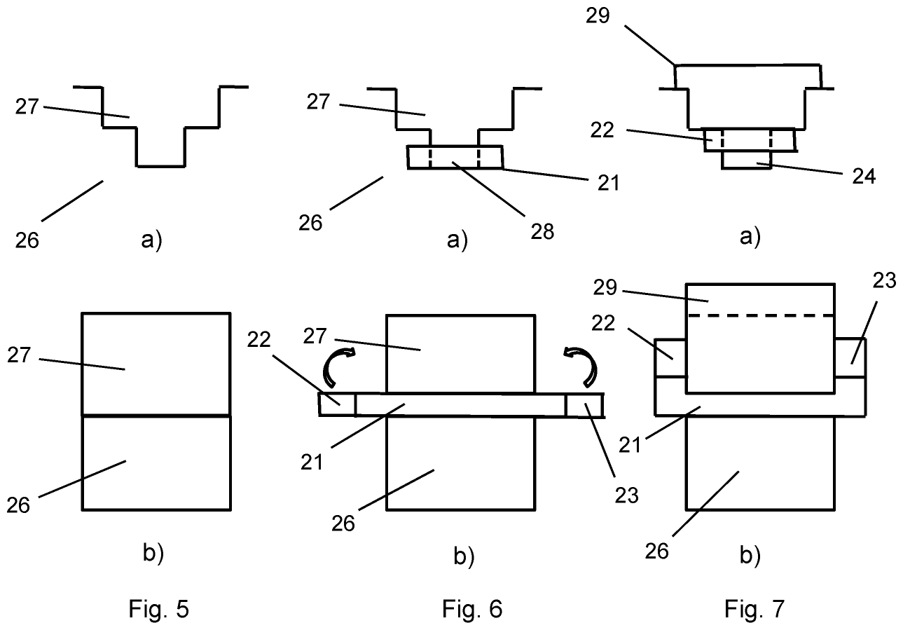

Another embodiment example is shown in FIGS. 4 to 8 with respect to a locking plate 21 for the axial securing of a rotating blade 20 of a turbomachine, for example of an aircraft engine, in a disk 26. In a schematic representation, FIG. 4 shows a rotating blade 20, having a blade element 30 and a blade root 29, which is introduced into a corresponding uptake groove 27 of a disk 26. A cross-sectional representation of a corresponding uptake groove 27 in a disk 26 is shown in FIG. 5 in figure part a), having a cross section crosswise to the longitudinal extent of the uptake element 27, and in figure part b), FIG. 5 shows a lengthwise section along the longitudinal axis of the uptake groove 27.

In order to securely hold the rotating blade 20 in the uptake groove 27 in the axial direction (referred to the axis of rotation of the disk), a locking plate 21, the ends of which are bent upward after introducing the blade root 29 into the uptake groove 27, is inserted in the groove base 28 of the uptake groove 27 (see FIG. 6), so that the bent-up bending ends 22 and 23 of the locking plate 21 that have a greater width W than the middle region of the locking plate 21 are applied to the end faces of the disk 26, so that the locking plate 21 can no longer be displaced in the axial direction corresponding to the length L of the locking plate 21 through the uptake groove 27. This is shown in FIGS. 6 and 7 in the figure parts a) and b), wherein FIG. 6 shows the locking plate 21 with the bending ends 22 and 23 in the undeformed state as it is arranged in the groove base 28 of the uptake groove 27. The arrows in figure part b) of FIG. 6 show how the bending ends 22 and 23 of the locking plate 21 are bent after introducing the rotating blade or the blade root 29 of a rotating blade, in order to hold the blade root 29 in the uptake groove 27, as is shown in FIG. 7 in figure part b).

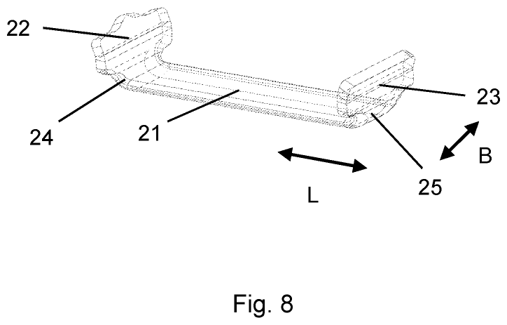

FIG. 8 shows the locking plate 21 in a perspective representation in an operating state when the bending ends 22 and 23 have already been bent, and each of which is connected to the middle region of the locking plate 21 via the curved regions 24 and 25, this middle region having a smaller width W than the bending ends 22, 23, in order to prevent an axial movement of the locking plate 21 through the uptake groove 27. The curved regions 24 and 25 represent the deformation form-fitting regions that have a low strength so that the bending ends 22, 23 can be bent and are then strengthened by precipitation hardening after the deformation. Correspondingly, the locking plate 21 and, in particular, the curved regions 24, 25 of the locking plate 21 are formed from a precipitation-hardenable material, wherein the locking plate 21 is inserted into the uptake groove 27 in a straight, flat, as yet uncurved state, and wherein the regions that are subsequently bent are present in a solution-annealed state of the precipitation-hardenable material. After the rotating blades have been introduced, the bending ends 22, 23 are bent, and the locking plate or the curved regions 24, 25 are subjected subsequently to an aging heat treatment in order to strengthen the curved regions 24 and 25.

Although the present invention has been described in detail on the basis of the embodiment examples, it is obvious to the person skilled in the art that the invention is not limited to these embodiment examples, but rather that modifications are possible in a way such that individual features are omitted or other kinds of combinations of features can be produced without departing from the protective scope of the appended claims. In particular, the present disclosure encompasses all combinations of the individual features shown in the different examples of embodiment, so that individual features that are described only in conjunction with one embodiment example can also be utilized in other embodiment examples, or combinations of individual features that are not explicitly shown can also be utilized.

What is claimed is:

1. A method for producing a subassembly having a form-fitting connection with a precipitation-hardened form-fitting region,
in which at least two components of a subassembly are provided, which are connected together in form-fitting manner, wherein each of the components has a form-fitting region that can come in contact with at least one other form-fitting region of the other component to be connected in order to produce a form-fitting connection by limiting at least one degree of freedom of movement of the connected components to one another, wherein at least one of the components has at least one deformation form-fitting region for providing the form-fitting connection that is reshaped for producing the form-fitting connection after arranging the components to be connected relative to one another, in order to produce the form-fitting connection, wherein the at least one deformation form-fitting region is formed from a material that can be hardened by formation of precipitations, wherein the deformation form-fitting region is provided in an unhardened state or is brought to an unhardened state by solution annealing and subsequent quenching, wherein the at least one component with the at least one deformation form-fitting region in the unhardened state of the deformation form-fitting region is arranged relative to the at least one other component to be connected, and the at least one deformation form-fitting region is reshaped for forming a form-fitting connection,
wherein, after the reshaping of the deformation form-fitting region, the deformation form-fitting region is subjected to an aging heat treatment, in which the deformation form-fitting region is hardened by formation of precipitations.

2. The method according to claim 1, wherein, in order to carry out the aging heat treatment, the deformation form-fitting region is locally heated or the component with the deformation form-fitting region or the subassembly with the connected components is heated.

3. The method according to claim 1, wherein the aging heat treatment takes place in a locally limited manner by an inductive heating and/or an energy-rich radiation.

4. The method according to claim 1, wherein the aging heat treatment takes place during operation or use of the subassembly.

5. The method according to claim 1, wherein the subassembly comprises at least two or three components, wherein one component is a rivet by which two other components are connected, or wherein one component is a pin having at least one depression or at least one elevation, configured as an annular circumferential depression or an annular circumferential elevation, and a corresponding component is a crimping element.

6. The method according to claim 1, wherein the component with the deformation form-fitting region is a locking plate for a blade arrangement in a disk of a turbomachine.

7. The method according to claim 5, wherein the rivet has at least one deformation form-fitting regions at the ends of the rivet, or the crimping sleeve has a deformation form-fitting region in the area of a cylinder surface of the sleeve, or the locking plate has at least one deformation form-fitting regions at the ends of the locking plate.

8. The method according to claim 1, wherein the reshaping of the deformation form-fitting region takes place by cold forming.

9. The method according to claim 1, wherein the deformation form-fitting region or the component having the deformation form-fitting region is made of a precipitation-hardenable, nickel-based alloy or a precipitation-hardenable cobalt-based material.

10. The method according to claim 1, wherein the solution annealing treatment of the deformation form-fitting region made of a nickel-based superalloy takes place at temperatures of 900° C. to 1200° C., for 0.5 to 5 h.

11. The method according to claim 1, wherein the quenching in water or oil or in air takes place after the solution-annealing treatment.

12. The method according to claim 1, wherein the aging heat treatment of the subassembly with a deformation form-fitting region made of a nickel-based superalloy takes place at temperatures of 550° C. to 850° C., for 1 to 15 h.

13. The method according to claim 1, wherein the subassembly has at least two components that are connected to one another in form-fitting manner, wherein each of the components has a form-fitting region that can come in contact with at least one other form-fitting region of the other component to be connected, in order to produce a form-fitting connection by limiting at least one degree of freedom of movement of the connected components relative to one another, at least one component of which has a precipitation-hardened form-fitting region.

14. The method according to claim 1, wherein the subassembly has a form-fitting connection with a precipitation-hardenable form-fitting region, comprising at least two components that are connected together in form-fitting manner, wherein each of the components has a form-fitting region that can come in contact with at least one other form-fitting region of the other component to be connected, in order to produce a form-fitting connection by limiting at least one degree of freedom of movement of the connected components to one another, wherein at least one of the components has at least one deformation form-fitting region for providing the form-fitting connection that is reshaped for producing the form-fitting connection after arranging the components to be connected relative to one another, in order to produce the form-fitting connection, wherein the at least one deformation form-fitting region is formed from a material that can be hardened by formation of precipitations, wherein the deformation form-fitting region is provided in the unhardened state and, during operation or when using the subassembly, is subjected to a temperature loading that corresponds to a precipitation heat treatment, so that precipitations are formed in the deformation form-fitting region.

15. The method according to claim 13, wherein a component has at least one form-fitting region for connection to another structure for the formation of a subassembly connected in form-fitting manner, in which the form-fitting region is composed of a precipitation-hardenable alloy.

16. The method according to claim 15, wherein the component is a rivet or a crimping sleeve or a locking plate.
